(19) United States
(12) Patent Application Publication
(10) Pub. No.: US 2024/0254688 A1
(43) Pub. Date: Aug. 1, 2024

(54) Recyclable artificial turf and HDPE backing layer for recyclable artificial turf

(71) Applicant: Ten Cate Thiolon B.V., Nijverdal (NL)

(72) Inventors: Colin Young, Nijverdal (NL); Salil Sethunath, Nijverdal (NL); Hein Anton Heerink, Nijverdal (NL); Michael Rene Vogel, Nijverdal (NL); Niels Gerhardus Kolkman, Nijverdal (NL)

(73) Assignee: Ten Cate Thiolon B.V., Nijverdal (NL)

(21) Appl. No.: 18/560,935

(22) PCT Filed: May 20, 2022
(86) PCT No.: PCT/EP2022/063809

§ 371 Date: Nov. 15, 2023

(30) Foreign Application Priority Data
May 21, 2021 (NL) 2028272

(51) Int. Cl. D06N 7/00; C08L 23/06; D01D 5/253; D01D 5/42; D01F 6/04; D03D 1/00; D03D 13/00; D03D 15/283; D03D 15/46; D03D 15/573; D03D 15/587; D05C 17/02; E01C 13/08

(52) U.S. Cl. CPC D06N 7/0068; C08L 23/06; D01D 5/253; D01D 5/426; D01F 6/04; D03D 1/00; D03D 13/008; D03D 15/283; D03D 15/46; D03D 15/573; D03D 15/587; D05C 17/023; D06N 7/0065; D06N 7/0078; E01C 13/08; C08L 2207/062; D06N 2201/0254; D06N 2203/042; D10B 2321/0211; D10B 2401/063; D10B 2505/202

(57) ABSTRACT

The present invention relates to a polyethylene backing layer for an artificial turf substrate consisting essentially of highly oriented, high density polyethylene filaments forming warp and weft threads, the high density polyethylene filaments having a density of at least 945 kg/m³ and a melt flow index of maximum 2 g/10 min. The invention further relates to filaments for making such a backing layer, a method for producing such filaments and an artificial turf substrate including such a backing layer.

### FIELD OF THE INVENTION

The present invention relates to artificial turf and in particular a backing layer for artificial turf made of high density polyethylene filaments and their method of manufacture.

### BACKGROUND ART

Artificial turf is well known from various publications and has been developed through a number of generations to its present form. In general, such systems seek to achieve the same characteristics as their natural counterparts although in certain areas these may have already been surpassed, at least in terms of predictability of behaviour. A distinction here is made between artificial turf intended for use in sport and play; and artificial grass that is used purely (or primarily) for landscaping.

First generation systems were typically made of green nylon yarn. The pile was very short and dense and not very comfortable for use in sports applications. Second generation systems were initially made of nylon yarns more recently transitioning to PP and PE, but with longer pile and using sand as an infill layer to keep the pile upright. Although second generation systems were better suited for sports applications, they still did not resemble natural grass very well.

Typical third generation turf systems comprise a carpet like layer, having upstanding pile fibres and an infill layer disposed between the pile fibres. The carpet has a backing layer, which may consist of a woven fabric of an appropriate material into which artificial grass fibres are tufted to provide the pile fibres oriented in an upward position. The pile fibres may comprise fibrillated tape or monofilaments of an appropriate polymer material or mixture of materials. The pile fibres may be fixed to the woven fabric by a coating of latex or polyurethane to reduce fibre pull-out. The infill provides for the required resilience of the pitch and may comprise soft granules of synthetic rubber or the like and/or natural materials such as sand or cork.

In fourth generation turf systems, the shock absorbing function of the infill may be integrated with the fibrous structure of the carpet. This can be achieved by careful selection of different fibres, to produce e.g. a thatch layer of curled fibres that extend less far than the pile fibres. In fourth generation systems, weaving of the complete artificial turf carpet is common as an alternative to tufting. The backing layer and the pile fibres are thus produced simultaneously by weaving on a loom. Here there is considerable freedom for the position of the pile fibres and the backing structure.

In both third and fourth generation systems, multiple different classes of material are used to achieve the correct mixture of properties in the individual layers of the final product. The term ‘layer’ is used here merely for convenience. It will be understood that a given function may be achieved by multiple layers and that one layer (and function) may coincide partially with another layer such as the infill layer may extend through the pile layer.

We can distinguish at least the following layers and functions that are relevant to the present discussion (although there are certainly further functions):
the backing layer, generally a woven textile, provides structural integrity in the horizontal direction and retains the pile fibres;
the pile layer, provides sports performance (ball-roll, ball bounce, sliding performance etc
the locking layer, prevents pull-out of pile from the backing layer;
the resilient layer, provides resilience and keeps the pile layer upright.

Although patent publications will indicate that any one or more of many different chosen materials could be used for any of these layers or functions, this is not the case. In reality, a limited number of materials can acceptably achieve the required functions of a respective layer. In particular, it should be appreciated that artificial turf is mainly expected to be used outdoors, where it is exposed to all possible environmental conditions.

Thus, in existing third and fourth generation systems, the backing layer is generally formed from woven polypropylene fibres. Typical fabric weight is between 80 and 400 g/m² and the fibres have a linear density between 300 and 1500 dtex. Polypropylene exhibits excellent stability to outdoor conditions, shows high creep resistance and has excellent longevity. Stability is important because temperatures on a pitch may vary between below freezing and up to 85 degrees Celsius if exposed to direct sun without suitable cooling provisions. Sufficient creep resistance is especially important for artificial turf applied on sports fields with even a minor slope for drainage, where static forces can otherwise lead to deformation over time of the artificial turf.

The pile layer is typically formed from polyethylene although polypropylene and polyamide materials may also occasionally be used. Polyethylene has been found to have the most optimal properties, in particular resiliency, for achieving the required functions of the pile layer. Attempts have been made to improve these functions further using coatings and mixtures of other materials but PE presently accounts for around 95% of the market for sports surfaces.

The locking layer is presently mainly provided by a latex coating on the backside of the backing layer. In North America, however, polyurethane is favoured.

The infill layer is presently perhaps the most varied layer in terms of choice of materials. Many existing pitches still use crumb rubber from recycled car tyres. This is presently being phased out and new installations favour natural materials such as cork and the like. For fourth generation turf systems, the infill layer/function may be provided by thatch fibres of e.g., fibrillated, curled, Knit-De-Knit (KDK) or texturized (TXT) yarns made of a polyolefin.

Although such systems provide excellent sports performance, at the moment of removal and disposal, the presence of multiple materials poses considerable additional difficulty and cost. The present invention attempts to further improve on such artificial turf systems by providing a comparable level of functionality while enhancing the ability to recycle the product at end of life.

### SUMMARY OF THE INVENTION

Accordingly, there is provided a polyethylene backing layer for an artificial turf substrate consisting essentially of highly-oriented, high density polyethylene (HDPE) filaments forming warp and weft threads, the high density polyethylene filaments having a density of at least 945 kg/m³ and a melt flow index of maximum 2 g/10 min.

In this context, “consisting essentially” means that at least 99 wt. % of the backing layer consists of highly oriented HDPE filaments. In each HDPE filament, at least 90 wt. % or even at least 95 wt % of the total weight of the filaments may be a high density polyethylene composition. In addition, the HDPE filaments may comprise additives such as fillers, pigments, UV stabilizers or processing aids. The term “highly oriented filament” is used to indicate filaments that have been formed in an extrusion process with a draw ratio of more than 4, preferably more than 5, and more preferably with a draw ratio between 6 and 7.

As noted above, conventional artificial turf uses different classes of polymer material for the backing on the one hand and for the pile fibres on the other hand. According to the invention, polyethylene is used for both layers and/or functions. While this may sound trivial in theory, the solution is not so in practice. As indicated above, the backing layer has until the present been made from polypropylene (PP), precisely due to its stability against temperature fluctuations during use and its good creep resistance. Polypropylene cannot however be effectively used as a pile fibre, since it is too rigid and it has not yet been possible to achieve the required sports performance properties with this material.

Presently, polyethylene (PE) is the most favoured material for the pile fibres. This has the right physical properties (e.g., flexibility) to exhibit acceptable sports performance properties for the range of fibre dimensions that are required. On the other hand, it has not been considered possible to use PE for the backing layer due to the fact that it is not suitably temperature stable when exposed to high temperatures as found during use or even encountered in production e.g. during application of a coating layer. In addition, attempts to produce a polyethylene backing have thus far failed, primarily due to insufficient creep resistance and dimensional stability with regards to the tufting process. In fact, the ability to extrude backing filaments of polyethylene has thus far been relatively limited, especially filaments of adequate strength for use as a replacement for polypropylene.

According to the present invention, the creep resistance of the artificial turf is improved by providing a backing layer made from a high density polyethylene material. The high density polyethylene (HDPE) material has a density of at least 945 kg/m³. The density may for instance be measured according to ISO 1183-1 or ISO 1183-2. Advantageous to the use of HDPE is the relatively large tensile strength, good creep resistance and good heat resistance in comparison to a polyethylene material with a higher degree of branching such as LDPE. More precisely, by using HDPE, a backing layer may be formed that has dimensional stability with regards to climate, strength and creep resistance that are at least similar to a backing layer made from PP.

In an embodiment, the filaments have one or more ribs along their longitudinal direction. This advantageously increases the roughness of the surface such that the filament becomes less prone to skewing both in use and during the tufting process. In an embodiment, the filaments may be provided with ribs or grooves on one or both sides. These may be imparted by the extrusion die, which may have profile features in the range of between 0.01 mm and 1 mm, in particular, between 0.1 mm and 0.6 mm. It will be understood that such features will be reduced proportionally during drawing down of the filament and may be present merely as light striations or ripples in the final filament. Nevertheless, they can assist in providing stability to the woven backing.

In an embodiment, the polyethylene has a density of at least 950 kg/m³. Although HDPE with a density of 945 kg/m³ may suffice, the mechanical properties of the backing layer such as strength and dimensional stability, e.g., shrinkage and creep resistance, may be improved for higher densities due to the lower branching degree and higher crystallization rate.

In embodiments, the density is between 950 kg/m³ and 970 kg/m³. For some types of HDPE, a lower density may improve the processability of the HDPE in an extrusion process that may be used to form the filaments. It will also be understood by the skilled person that the strength of the filaments of the backing is highly dependent on their degree of orientation and the draw ratio to which they have been exposed. Higher density polyethylene can better be drawn although it should be appreciated that it is also susceptible to shrinkage during use. Heat stabilisation of the backing prior to use is therefore recommended as further detailed below. Higher density is also associated with a higher melting point, which is desirable for reasons discussed further below.

In an embodiment, the molecular weight of the HDPE is between 200,000-500,000 g/mol. Similar to the effects of a higher density, a larger molecular weight also contributes to a higher melting point and improved creep resistance. Nevertheless, a molecular weight that is too high may lead to poor processability in an extrusion process.

In an embodiment, the HDPE has a medium or medium-broad molecular weight distribution (MWD). HDPE with a too narrow molecular weight distribution would reduce the processability of the HDPE in an extrusion process as it makes the processing window very narrow. It is nevertheless the case that a narrow MWD may be associated with a more defined melting temperature, which may be advantageous for reasons to be given further below. HDPE with a too broad molecular weight distribution may also be less preferable in terms of its mechanical properties. Hence preferably the HDPE has a molecular weight distribution (MWD) as narrow as possible, while maintaining good processability of the HDPE in an extrusion process. Preferably, the HDPE has a unimodal weight distribution curve.

The melt flow index (MFI) of the HDPE of the filaments is at most 2 g/10 min. The MFI is measured according to ISO 1133-1. Such a relatively low MFI is advantageous because for a higher MFI the creep resistance of the backing layer is lower. It will be understood by the skilled person that the HDPE composition also has a certain minimum melt flow index (MFI). In embodiments, the MFI is at least 0.7 g/10 min or at least 1.2 g/10 min.

In an embodiment, the melt flow index (MFI) of the HDPE composition of the filaments is between 1.5 g/10 min and 2 g/10 min, preferably between 1.7 g/10 min and 1.9 g/10 min. A HDPE composition with a MFI within these ranges has a good processability in an extrusion process. A lower MFI may lead to a too high die pressure in the extruder and consequently a lower throughput. Conversely, a higher MFI may give problems during the stretching of the filaments or extruded films, leading to uneven drawing. Hence a MFI within these ranges is advantageous for both the processability of the HDPE composition in an extrusion process as well as for the stability properties of the backing layer.

According to an embodiment, the HDPE has a melting point of at least 125 degrees Celsius, preferably at least 128 degrees, and more preferably around 130 degrees. This is advantageous for the subsequent use of the backing layer in an artificial turf substrate when melting the pile fibres of the artificial turf substrate to enhance the fibre bond strength as discussed in relation to a further aspect of the invention below. Because the melting point of the backing layer is higher than the melting point of the pile fibres in the artificial turf substrate, the pile fibres may be melted to each other while the backing layer remains intact. Preferably, a HDPE having a melting point as high as possible is selected. Currently available HDPE compositions have a melting point around 130 degrees.

The skilled person will be aware that for polymer materials, melting actually takes place over a range of temperatures. In the following, melt temperature will refer to the peak temperature as measured by Differential Scanning calorimetry (DSC). This is distinct from the onset temperature, sometimes referred to as the extrapolated onset-temperature (according to DIN EN ISO 11357-1:2010-03). This is the calculated intersection point of the extrapolated baseline and the inflectional tangent at the beginning of the melting or crystallization peak. According to an aspect of the invention, the HDPE composition may be selected to have an onset temperature that is above the melting temperature of the pile fibres.

The warp and weft filaments in the backing layer may be monofilaments or slit films. In an embodiment, at least some of the filaments are tapes. The term “tape” refers to a unidirectional oriented polymer product, preferably with a linear density (or titer) between 100 dTex and 2500 dTex. The tapes can have a rectangular or square cross section and are preferably formed by slitting extruded films. The tapes typically have a thickness between 50 and 120 μm, preferably between 70 and 100 μm, and a width between 0.5 and 5 mm, preferably between 1 and 3 mm. These thicknesses and widths refer to the thickness and width of a tape as drawn during an extrusion process and ready to weave. Wider tapes might lead to faults in the woven backing layer, whereas narrower tapes would not be effective due to their insufficient strength.

In a further embodiment, the backing layer is a primary backing layer, suitable for tufting. A primary backing layer is defined as the layer through which the pile fibres are positioned after tufting. Preferably, the filaments of the primary backing layer are formed by tapes. Alternatively, the backing layer may be part of three-dimensional woven artificial turf substrate. Weaving of the complete artificial turf carpet is common as an alternative to tufting. The woven artificial turf comprises a backing layer and pile fibres that are produced simultaneously by weaving on a loom. The woven artificial turf substrate comprises warp and weft threads. Most preferably, the woven artificial turf is produced in a face to face weaving process with the pile fibres also being present in the warp.

In an embodiment, the backing layer is woven using a plain weave. A plain weave is well suited for tufting.

In an embodiment, the number of warp filaments per unit length and weft filaments per unit length are different. This is advantageous for the tuftability of the backing layer. In the production of artificial turf, a key goal is to avoid unnatural appearance such as an overly regular pattern. A variation between warp and weft reduces the so-called Moire effect in tufting and thereby also reduces aesthetic defects.

In an embodiment, the ratio of the number of warp filaments to the number of weft filaments is substantially the same as the inverse of the ratio of the linear density of a warp filament to the linear density of a weft filament. Here “substantially the same” refers to a maximum difference of 15% between the ratio's. This leads to a backing layer with good tuftability and a similar strength in the warp direction and the weft direction. The effects in terms of strength are similar to when the number of warp filaments per unit length and weft filaments per unit length is substantially the same, and the warp filaments and weft filaments have substantially the same linear density. Such a so-called square construction, wherein the arrangement of warp and weft filaments is substantially the same, contributes to the dimensional stability of the backing layer (see for example U.S. Pat. No. 6,897,170 B2) and ensures that the individual tapes lay flat in the fabric without twisting. This leads to a low fabric shrinkage and thus a backing layer with better dimensional stability. In addition, the backing layer may have a similar strength in both the warp direction and the weft direction. A fabric wherein the ratio of the number of warp filaments to the number of weft filaments is substantially the same as the inverse of the ratio of the linear density of a warp filament to the linear density of a weft filament combines the advantageous effects of a square construction and a non-square construction that has good tuftability. This arrangement is referred to as a “biased square construction.” Alternatively, in embodiments a full square construction may be used, wherein the number of warp filaments per unit length and weft filaments per unit length is substantially the same, and the warp filaments and weft filaments have substantially the same linear density.

In an embodiment, the backing layer may comprise a plurality of sublayers. The plurality of sublayers can be stacked on top of each other or stitched or bonded to each other to together fulfil the function of the backing layer of providing structural integrity in the horizontal direction and retaining the pile fibres. The plurality of sublayers together form the primary backing layer suitable for tufting. A preferred method of joining such layers is by warp-knitting. In an embodiment, the backing layer consists of two sublayers that are identical to each other.

In another embodiment, the filaments of the backing layer have a linear density between 100 and 2500 dtex, preferably between 200 and 1700 dtex. Examplary values may lie between 600 dtex and 1200 dtex.

The filaments should be as strong as possible subject to other constraints. In an embodiment, the filaments have a tenacity of at least 20 cN/Tex, preferably wherein the filaments have at least a tenacity of 25 cN/Tex. More importantly, the filaments may have a tenacity of greater than 10 cN/Tex at 5% elongation or even greater than 12 cN/Tex at 5% elongation.

In an embodiment, the backing layer has a fabric weight between 80 and 400 g/m², preferably between 100 and 300 g/m². Such weight allows for applicability of the backing layer in most sport applications as well as in artificial grass that is used primarily for landscaping.

In an embodiment, the filaments may further comprise one or more additives preferably selected from the group comprising antioxidants, UV stabilizers, pigments, processing aids, acid scavengers, lubricants, antistatic agents, fillers, nucleating agents, and clarifying agents. These additives may preferably be added as a masterbatch to the melt prior to extrusion. In embodiments, the filaments comprise 3 to 6 wt. % of pigments and UV stabilizers and/or 0 to 2 wt. % of processing aid. The amount of filler is typically between 2 wt % and 6 wt. % and may be different for filaments used in the warp and weft direction, depending on the characteristics required.

In an embodiment, the filaments have a strain at break between 10 and 40%, preferably between 20 and 35%. It will be understood by the skilled person that a low strain value of the individual filaments generally corresponds to a high creep resistance of the backing layer and is thus advantageous for use in the backing layer of artificial turf. Nevertheless, some resilience is required to prevent the filaments from snapping during weaving. Alternatively, creep of the backing layer itself may be measured. According to an embodiment, the backing layer has a creep strain rate after 5 h of at most 1.0%/h, preferably at most 0.5%/h, more preferably at most 0.1%/h. The creep strain rate may be determined on a Zwick tensile tester by applying a constant load during 5 hours at 50 degrees Celsius. After 5 hours, the creep strain rate can be found as the difference in gauge length at hour 4 and hour 5 and divided by the gauge length at hour 4.

In an embodiment, the backing layer has been heat-stabilized by heating the backing layer above onset temperature of the HDPE. The heat-stabilization relaxes the strain developed in the filaments during the weaving process. It will be understood that weaving generally takes place at ambient temperatures at which the filaments have a given modulus. The weaving action creates bends and twists in the filaments, which remain once the process is completed. If the temperature of the backing layer is elevated, the induced strain can recover by relaxation and straightening of bends in the filaments. In an embodiment, heat-stabilization may take place in combination with locking of the pile fibres e.g. in a melting process as will be detailed further below. This is particularly important in the case of three dimensional woven artificial turf.

According to a second aspect of the invention and in accordance with the advantages described hereinabove, there is provided a method of manufacturing a backing layer. The method comprises providing a plurality of highly oriented, high density polyethylene filaments having a density of at least 945 kg/m³ and a melt flow index of maximum 2 g/10 min; and weaving the backing layer, wherein the high density polyethylene filaments are used both as warp threads and as weft threads. Preferably, a backing layer according to the invention as discussed above is obtained.

In an embodiment, the method further comprises heat-stabilizing the backing layer. The heat-stabilization may be performed using a variety of different methods.

In an embodiment, heat-stabilization takes place by feeding the substrate along a body having a heated surface, a first surface of the backing layer being arranged to contact the heated surface. The heated surface may be a roller or calendar as is generally known in the art.

In another embodiment, the heat-stabilization is performed by guiding the backing layer through an oven or ovens without direct contact with a heated surface. For example, a tenter frame may be used to guide the backing layer through the oven. In one embodiment, the backing layer is guided through an oven having a temperature between 135 and 155 degrees with a residence time between 10 and 120 seconds.

It will be understood that the precise details of the heat-stabilization process will generally be adapted to the particular artificial turf product being manufactured, the specific type of HDPE that is used and the method of heat-stabilization. Typically, the process may ensure that the backing layer is heated to a temperature above the onset temperature of the polyethylene.

According to a further aspect of the invention and in accordance with the advantages described above, there is provided a method of manufacturing a polyethylene, heat-stabilized artificial turf substrate, the method comprising providing a high density polyethylene backing layer according to the invention, the backing layer having an upper surface and a lower surface; integrating pile fibres into the backing layer to be upstanding from the upper surface, wherein the pile fibres comprise polyethylene; and bonding the pile fibres to the backing layer to prevent fibre pull-out.

The pile fibres are preferably integrated in the backing layer through tufting. The pile fibres can protrude through the backing layer as loops, or the loops may be cut open. Alternatively, a full woven artificial turf substrate may be formed wherein the backing layer is formed simultaneously with the integration of the pile fibres.

In the present context, bonding of the pile fibres is intended to refer to mechanical, physical or chemical bonding that is in addition to the step of integrating the pile fibres into the backing layer. It thus creates a greater pull-out strength than would be the case after the integration of the pile fibres due to the tufting or weaving step alone. It may involve melting, fusing, adhering, encapsulating, coating or the like, subject to the limitation that it does not introduce a different material and the resulting substrate remains a single-polymer artificial turf substrate.

In the following, the term “fusing” is used to refer to the situation where two components or fibres are fully melted together i.e. to form an integral component. Melting may merely cause one component to mould around the other component without actual bonding or fusing taking place. In this case, once cooled, there may be merely a mechanical bonding of the two components e.g. the pile fibres and the woven backing layer.

In one embodiment, bonding the pile fibres is accomplished by feeding the substrate along a body having a heated surface, the lower surface of the backing layer being arranged to contact the heated surface. This may be achieved using conventional machines as mentioned above. Nevertheless, it may be noted that adaptation of the process to achieve the presently described result is desirable. In particular, the time and temperature required to achieve bonding of the pile may be different to those required to achieve a heat-stabilized backing layer. For bonding, it is necessary to exceed the melting point of the material of the pile fibres. Preferably, this is done momentarily and locally to avoid significant damage to the substrate structure and the fibre properties. In a particular embodiment, the heated surface contacts only the pile fibres without making direct contact with the backing material itself. In the case of heat-stabilization, a lower temperature is required that should penetrate more generally into the substrate structure to regions where strain is present.

In an embodiment, the heated surface is between 135 and 155 degrees Celsius and a contact period is between 20 and 35 seconds, preferably between 25 and 30 seconds. This period is sufficiently long to bond the pile fibres together, without damaging the backing layer. The heated surface is preferably around 145 degrees Celsius.

In an embodiment, a roller is arranged opposite to the heated surface to pressurize the backing layer, preferably wherein a pressure between 2 and 8 Bar is applied. The roller, preferably a laminating roller, ensures that all pile fibre bundles at the lower side of the backing layer are in good contact with the heated surface. When no pressure or insufficient pressure is applied not all pile fibres may melt.

Alternatively or additionally, bonding may comprise applying a hot melt or powder melt to the lower surface of the backing layer or by laminating the lower surface of the backing layer with a polyethylene film whereby lamination takes place by melting the film. Again, it is a requirement in all of these cases that this additional layer comprises polyethylene. The only exception to this would be if the additional layer were readily removable in or prior to a recycling process. The additional layer may further strengthen the bond between the pile fibres and the backing, making the artificial turf suitable for applications wherein high demands are made on the fibre pull-out strength.

In one embodiment, the method comprises actively cooling the substrate thereby securing the pile fibres to the backing layer. After thermally bonding or heat-stabilization, the substrate may be cooled down by removing the source of heat, e.g., a heated surface, infrared beam or hot air blower. Alternatively, the substrate may be actively cooled down, for instance by carrying the carpet along a cold surface or by supplying cold air along the lower surface of the backing layer.

According to a further aspect of the invention and in accordance with the advantages and effects described hereinabove, there is provided an artificial turf substrate consisting essentially of polyethylene material, the artificial turf substrate comprising a backing layer comprising backing filaments and pile fibres upstanding from the backing layer, wherein the backing filaments comprise polyethylene having a first density and the pile fibres comprise polyethylene having a second density, wherein the ratio between the first and second density is at least 1.01, preferably at least 1.02. The backing layer typically has a density of at least 945 kg/m³, whereas the density of the pile fibres is preferably significantly less than 945 kg/m³, for example between 915 and 935 kg/m³. The difference in density generally translates to a difference in melting temperature.

According to yet a further aspect of the invention and in accordance with the advantages and effects described herein above, there is provided an artificial turf substrate consisting essentially of polyethylene material, the artificial turf substrate comprising a backing layer comprising backing filaments and pile fibres upstanding from the backing layer, wherein the backing filaments comprise polyethylene having a first melting temperature and the pile fibres comprise polyethylene having a second melting temperature, wherein the difference between the first and second melting temperature is at least 2 degrees Celsius, preferably at least 3 degrees Celsius and may be more than 5 degrees Celsius. The backing layer preferably has a melting temperature of at least 130 degrees Celsius, whereas the melting temperature of the pile fibres is typically less than 127 degrees Celsius. The different melting temperature enables the pile fibres to be fixated in the backing layer through melting of the pile fibres without melting or even softening of the filaments of the backing layer.

The skilled person will understand that the properties imparted on the filaments and fibres during the extrusion process can be negated on melting. In particular, in this manner the molecular orientation of the filament material of the backing can be retained if subsequent processing remains distant from the melting temperature of the filaments. In an embodiment, bonding of the pile fibres may take place without exceeding the onset temperature of the backing filaments. This may be the case where the melting temperature of the pile fibres is below the onset temperature of the backing filaments.

In an embodiment, the backing layer is a backing layer according to the invention.

In an embodiment, the backing layer has an upper surface and a lower surface and the polyethylene pile fibres are upstanding from the upper surface, the pile fibres being tufted in the woven backing layer and bonded to each other or to the backing layer at the lower surface. As explained above, polyethylene is a preferred material for the pile fibres due to its resilience and forming both the backing layer and pile fibres from the same material eases recycling as explained above.

In one embodiment, the artificial turf substrate comprises at least 90 wt % or at least 95 wt % or at least 98 wt. % of polyethylene, preferably at least 99 wt. % of polyethylene. It will be understood that for recycling purposes, the weight percentage of the polymer material is as close to 100 wt. % as possible. Nevertheless, it will be understood that various additives can be present and other contamination may occur. It is at least important that the weight percentage is sufficiently high to not lead to significant disadvantages during recycling.

In one embodiment, the pile fibres comprise bundles of monofilaments, preferably having different characteristics, and more preferably wherein the bundles are between 10 000 dtex and 15 000 dtex. The monofilaments may themselves be between 1000 and 3000 dtex per filament. In a preferred embodiment at least the cross-sectional shape varies between the monofilaments, but also the colour, stiffness and pile height may vary to mimic natural grass. The cross-sectional shape may for instance be flat, V-shaped, lenticular, curved, wave-shaped, tri-lobal, hollow or the like. Alternatively, or in addition, the pile fibres may comprise fibrillated tape.

In one embodiment, the bundles of monofilaments are at least partly melted to each other. This prevents the individual pull out of the pile fibres and anchors the pile fibres in the backing layer. For example, as described in relation to the method for manufacturing the artificial turf substrate, such melting may be accomplished by feeding the substrate along a body having a heated surface having a temperature exceeding the melting point of the polyethylene in the pile fibres, the lower surface of the backing layer being arranged to contact the heated surface to cause melting or softening of the pile fibres.

According to a further aspect of the invention and in accordance with the advantages and effects described herein above, there is provided a highly-oriented, high-density polyethylene filament suitable for manufacturing a backing layer according to the invention. As HDPE filaments for manufacturing a backing layer were not readily available, they have been specifically designed for this purpose. An arbitrary HDPE composition cannot be easily processed in an extrusion process to form the tapes by slitting an extruded film. It is therefore a further object of the invention to provide a HDPE composition that has both good processability, as well as the desired strength, stability and creep resistance as required for its application in artificial turf.

According to a further aspect of the invention and in accordance with the advantages and effects described herein above, there is provided a method of manufacturing a high density polyethylene filament for a backing layer of an artificial turf substrate, the method comprising providing a high density polyethylene composition having a density of at least 945 kg/m³ and a melt flow index between 1.5 and 2 g/10 min to an extruder; forming filaments; and drawing the filaments in a machine direction to obtain a filament having a linear density between 100 and 2500 dTex. Preferably the HDPE has a medium or medium-broad molecular weight distribution.

According to an embodiment, the filaments are tapes and the step of forming the filaments comprises extruding the polyethylene composition into an extruded film and slitting the film into tapes. A HDPE composition is provided to an extruder, which extrudes the HDPE into a film. Such a film may be prepared by any conventional film formation process including extrusion procedures such as cast film extrusion. After the film is formed, it is subsequently slit into tapes and stretched. The film may be stretched before cutting the film into tapes, the film may first be cut and stretched afterwards, or the cutting and stretching may be carried out simultaneously. Preferably, the film is first cut to tapes, which are subsequently stretched in a machine direction in a desired draw ratio to form the final tapes. In an embodiment, the film is extruded through a profiled die having at least one ribbed surface.

In an embodiment, the draw ratio in the machine direction is at least 4, preferably at least 5, more preferably at least 6. For example, the draw ratio may be between 6 and 7. The draw ratio indicates the number of times that the tape is stretched in the machine direction in comparison to its original length.

### BRIEF DESCRIPTION OF THE DRAWINGS

The present invention will be discussed in more detail below, with reference to the attached drawings, in which:

FIG. 1A schematically shows a perspective view of part of a heat-stabilized artificial turf substrate according to a first embodiment.

FIG. 1B schematically shows a side view of the artificial turf substrate in FIG. 1A, taken in the direction I-B.

FIG. 2 diagrammatically shows a method to manufacture the heat-stabilized artificial turf substrate according to the first embodiment.

FIG. 3 shows a first embodiment of an apparatus that can be used for the pile fibre bonding step according to the method shown in FIG. 2.

FIG. 4 shows a cross-section through part of an extrusion die for forming a filament according to the invention.

FIG. 5 shows a typical Differential Scanning calorimetry curve for the filament material.

The figures are meant for illustrative purposes only, and do not serve as restriction of the scope or the protection as laid down by the claims.

### DESCRIPTION OF EMBODIMENTS

The following is a description of certain embodiments of the invention, given by way of example only and with reference to the figures.

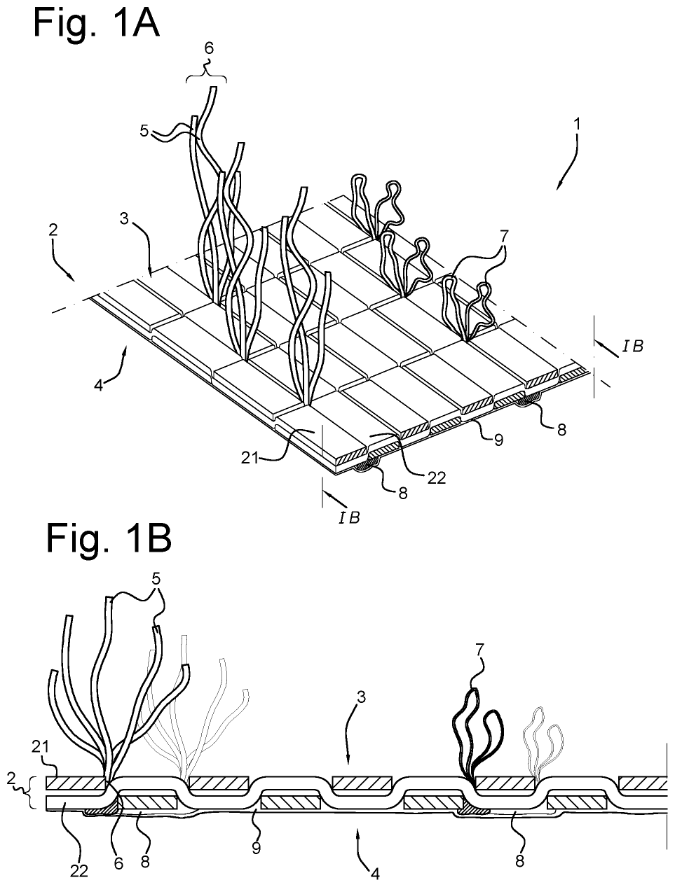

FIG. 1A schematically shows a perspective view of a heat-stabilized artificial turf substrate 1 according to the invention made exclusively of polyethylene. FIG. 1B shows a side view of the artificial turf substrate in FIG. 1A. The artificial turf substrate 1 comprises a backing layer 2 having an upper surface 3 and lower surface 4. The backing layer 2 is a woven fabric, having warp tapes 21 and weft tapes 22 each formed as HDPE extruded tape. From the upper surface 3, polyethylene pile fibres 5 and thatch yarns 7 are upstanding. The pile fibres 5 are provided as a bundle 6 of monofilaments that each have different characteristics, such as cross-sectional shape, shade of green, stiffness and/or pile height, to mimic natural grass as well as possible. The pile fibres 5 are tufted into the backing layer 2 and at the lower surface 4 of the backing layer 2 the bundles 6 of pile fibres 5 are fused together, proving a melted pile fibre bundle 8 below the backing layer 2. A polyethylene coating layer 9 is provided at the lower surface 4 to provide extra strength.

The pile fibres 5 are tufted into the carpet along the warp direction, such that the melted bundle 8 of pile fibres 5 extends along the warp direction below the lower surface 4 at the backing layer 2. The melted bundle 8 has a width of a few millimetres and therefore extends over the width of a plurality of warp tapes 21. This makes the fibre bind rather strong and the pile fibre breaks before it is pulled out. The melted pile fibre bundle 8 is arranged in a zigzag pattern below the backing layer 2, zigzagging over a total width of approximately 5 mm. The warp tapes have a width of approximately 1 mm and the weft tapes have a width of approximately 2 mm. Consequently, the melted bundle of pile fibres spans the width of at least two or three tapes.

The artificial turf substrate 1 has similar mechanical properties to a conventional artificial turf substrate made with a PP backing layer and retains the pile fibres equally well. Advantageously, due to the product comprising only PE, the product can be easily recycled at the end of life of the product.

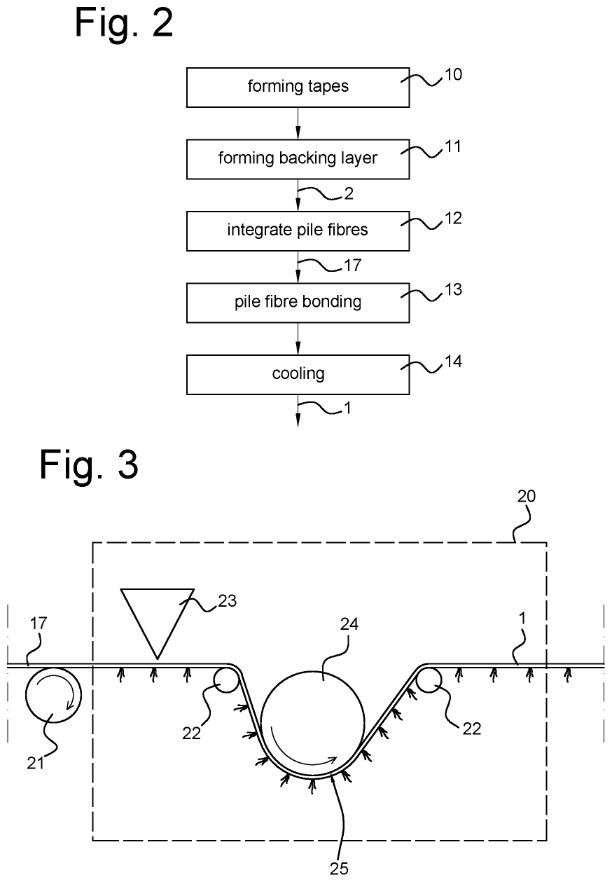

FIG. 2 diagrammatically shows a method for manufacturing such an artificial turf substrate 1. First, a plurality of tapes 21, 22 is manufactured from a HDPE composition in a tape forming step 10, which are thereafter used to form a backing layer 2 at step 11. After that, the pile fibres 5 are integrated into the backing layer 2 in an integration step 12, preferably through tufting. Alternatively, the woven backing 2 and pile fibres 5 may be integrally formed by weaving the pile fibres 5 into the woven backing 2 using a weaving technique for manufacturing a three-dimensional artificial turf structure 1. The backing layer 2 with integrated pile fibres 5 is referred to as an intermediate product 17, which generally looks rather similar to the artificial turf substrate 1 as depicted in FIG. 1, but the pile fibres 5 are not anchored in the backing layer 2 and therefore the intermediate product 17 has inferior mechanical properties in comparison to the final artificial turf substrate 1. To enhance the fibre-bind strength and prevent fibre pull-out, the intermediate product 17 is subjected to a bonding step 13 wherein the lower surface 4 of the backing layer 2 is heated to a temperature above the melting point of the PE in the pile fibres to thermally bond the pile fibres 5 in the bundles 6 to each other and/or to the backing layer 2 and strengthen the fibre-bind. During the bonding step 13, the backing layer 2 is heated to a temperature and for a time sufficient to stabilise the backing layer 2 to temperatures to be encountered in use. After the bonding step 13, the product is cooled down to room temperature in a cooling step 14.

The artificial turf substrate 1 in FIG. 1 is made of a mixture of different polyethylene compositions. Here the term “polyethylene composition” is used to indicate the composition of the raw polyethylene that is extruded to form tapes for the backing layer 2 and to form the pile fibres 5 for the pile layer.

The tapes in the backing layer 2 are made of a HDPE composition. As explained above, HDPE has good tensile strength, good creep resistance and good heat resistance in comparison to a polyethylene material with a higher degree of branching such as LDPE.

### Backing Filaments—Example 1

According to a first embodiment, the HDPE is ELTEX B4020N1332, a high density polyethylene copolymer manufactured by INEOS Olefins & Polymers Europe, and has a density of 952 kg/m³ as measured according to ISO 1183-1. The HDPE has a unimodal weight distribution curve and molecular weight distribution (MWD) that is sufficiently broad to enable good processability of the HDPE in an extrusion process.

The HDPE composition has a melt flow index (MFI) of 1.9 g/10 min. Preferably, the MFI is selected between 1.5 and 2 g/10 min. A lower MFI could lead to a too high die pressure in the extruder and consequently a lower throughput. Conversely, a higher MFI could give problems during the stretching, leading to uneven drawing. Hence a MFI between 1.5 and 2 g/10 min is advantageous for the processability of the HDPE by the extruder. In addition, a higher MFI reduces the creep resistance.

The HDPE composition is provided to an extruder, which extrudes the HDPE into a film. Such a film may be prepared by any conventional film formation process including extrusion procedures such as cast film or blown film extrusion. After the film is formed, it is quenched in water and subsequently slit into tapes and stretched. The film may be stretched before cutting the film into tapes, the film may first be cut and stretched afterwards, or the cutting and stretching may be carried out simultaneously. Preferably, the film is first cut to tapes, which are subsequently stretched in a machine direction in a desired draw ratio to form the final tapes. A draw ratio of 6 is used, which indicates that the tape is stretched six times in the machine direction in comparison to its original length. The tapes are then relaxed and annealed on rolls.

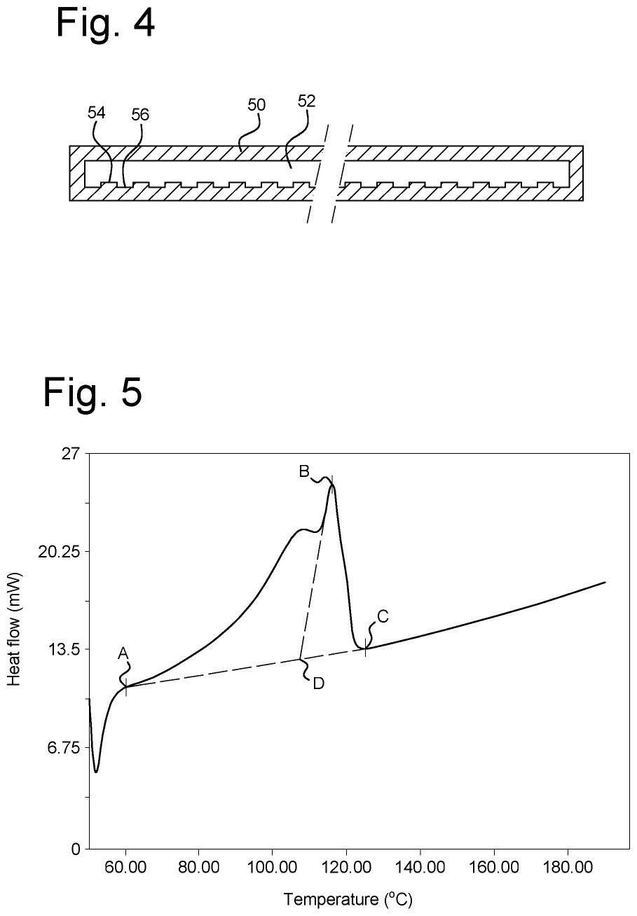

FIG. 4 illustrates part of the extruder die 50, which has an overall width of around 1 metre. The die opening 52 has a nominal opening of 0.6 mm but is provided with a pattern of rectangular ribs 54 and grooves 56 on its lower side having a depth of 0.15 mm and a width of 0.5 mm. The film exiting the die 50 has a cross-sectional profile corresponding to the die opening 52. Once it is drawn down, the cross-section of the film will reduce accordingly and profile features will be reduced by the square root of the draw ratio. In addition, flow of the extrudate will tend to soften all features, whereby the final tape will have a shallow ripple-like surface on its lower side at a spacing of around 0.2 mm. The formed tape has a tenacity of around 25 cN/Tex.

The formed tapes are used to weave a backing layer for artificial turf. Preferably, the warp and weft tapes in the backing layer are woven in a plain weave and arranged to resemble a so-called biased “square construction”. This typically means that the average numbers of tapes, the tape width, the tape thickness and linear density of the tapes is similar in both the warp and weft direction, having advantageous effects on the dimensional stability of the backing layer. Nevertheless, also non-square weaving patterns may be used.

### Backing Layer—Example 1

According to a first example, the backing layer 2 is a single layer woven fabric, for example as shown in FIGS. 1A and 1B. The backing layer 2 has a plain weaving pattern using tapes as described in the first example. The warp tapes have a linear density of 670 dtex and the weft tapes have a linear density of 1200 dtex. On average, about 860 warp tapes and 610 weft tapes are provided per meter. The warp tapes have a width of 1.2 mm, the weft tapes have a width of around 2.2 mm, and both the warp and weft tapes have a thickness of 58 μm. This leads to a fabric weight of approximately 129 g/m².

### Backing Layer—Example 2

According to a second example, the backing layer is also formed of tapes as described in the first example. The backing layer comprises two substantially identical sublayers that are stacked on top of each other and bonded to each other, for example by warp-knitting the first sublayer and the second sublayer together. The woven backing layer thus comprises two layers of warp tapes and weft tapes that together form one backing layer that functions as the pile carrying layer. The warp tapes 21 in each sublayer have a tape width of 1.2 mm, a linear density of 670 dtex and about 840 threads per meter. The weft tapes 22 each have a tape width of 2.2 mm, a linear density of 1200 dtex and about 420 weft threads per meter. The warp threads have a thickness of approximately 59 μm and the weft threads have a thickness of approximately 57 μm.

In both examples, the backing layer 2 has a different number of tapes in the warp direction and in the weft direction. This was found to be advantageous for the tuftability of the backing layer 2. To balance the variation in the number of tapes while still obtaining a backing layer 2 with the preferable dimensional stability of a square construction, the linear density and tape width of the weft tape 22 is approximately two times larger than the linear density and tape width of the warp tape 21. More precisely, per meter width, the linear density in warp direction is 670*840=562800 dTex/m and in weft direction 1200*420=504000 dTex/m. Hence the deviation is less than 15%, and therefore an approximate biased square construction is obtained in the backing layer according to the second example.

In the second example the number of warp tapes multiplied with the linear density of the warp tapes is slightly larger than the number of weft tapes multiplied with the linear density of the warp tapes. This is advantageous as it may compensate for the reduction of strength in the warp direction due to damage of the filaments from the weaving process.

The fabric according to the first and second example has sufficient strength and dimensional stability to be used as a backing layer in artificial turf. Mechanical properties of the first and second examples are summarized in Table 1. Optionally, the backing layers may be heat-stabilized before tufting to improve its stability. Table 1 shows the results for example 1 both before and after heat-set.

TABLE 1

| | | Strength at | Strength at | Strain at | Strain at | Shrinkage | Shrinkage |
|---|---|---|---|---|---|---|---|
| | Weight | Fₘₐₓ MD | Fₘₐₓ CD | Fₘₐₓ MD | Fₘₐₓ CD | at 90° C. | at 90° C. |
| Backing layer | [g/m²] | [N/5 cm] | [N/5 cm] | [%] | [%] | MD [%] | CD [%] |
| Example 1 | 129 | 717 | 914 | 18 | 16 | 3.6 | 3.2 |
| Example 2 | 217 | 1565 | 1194 | 18 | 13 | 4 | 3.2 |
| Example 1 | 140 | 894 | 1105 | 23 | 19 | 0.8 | 0.8 |
| (heat-set) | | | | | | | |

The strength at Fmax refers to the force [N] required to break or tear a strip of 5 cm thickness, in the machine direction (MD, warp direction) or cross machine direction (CD, weft direction), respectively. The elongation at Fmax refers to the corresponding strain that occurs while performing this test. Generally, stronger fabrics are more stable and have a higher creep resistance.

The shrinkage at 90 degrees refers to the shrinkage that is to be expected in the field when the artificial turf is exposed to direct sun light. It is measured by marking a sample with a specified length and exposing to 90 degrees C. for a period of 15 minutes. After cooling, the marked length is measured again and the shrinkage is determined. Due to the method of fabrication of a woven backing, inherent stresses are created in the fibres of the woven backing layer. On exposure to heat, the fibres relax and the weave structure ‘spreads’. This phenomenon has different names but may be referred to as creep, stretching or spread. It is not a simple matter of thermal expansion, since it does not necessarily reverse on cooling. Spread can cause a carefully laid artificial turf pitch to pucker or ruck up unacceptably. Hence the shrinkage is preferably as low as possible.

To form the artificial grass, pile fibres 5 are integrated into a backing layer according to the invention to form an intermediate product 17. The PE composition for the pile fibres has a lower density and a lower melting point than the HDPE composition applied in the backing layer. Preferably, the melting point of the pile fibres 5 is below 115 degrees Celsius. This difference in melting point between the bundles 6 of the pile fibres 5 and the backing layer 2 allows the bundles 6 to be melted to each other during the bonding step 12, while the backing layer 2 does not melt.

In a specific embodiment, the pile fibres 5 are made of PE having a melting temperature of 110 degrees Celsius. The bundles 6 that have been tufted into a HDPE backing layer 14 different monofilaments with a linear density of 900 dtex each and leading to total linear density of 12600 dtex. These pile fibres 5 extend over a height of 4.3 cm and may have different properties to mimic the appearance of natural grass.

In addition, texturized or curled thatch yarns 7 are integrated in the backing layer 2 that extend less far. The thatch yarns 7 are arranged in bundles having a total linear density of 5000 dtex comprising 8 yarns each. The thatch yarns 7 are made of PE having a melting temperature of 125 degrees Celsius.

Generally the fibre-bind strength of the intermediate product 17 is insufficient and therefore in prior art artificial turf systems typically a locking layer, for example a latex coating, is applied. As this would compromise the recyclability of the artificial turf substrate, the intermediate product 17 is according to the invention subjected to a bonding step 12 wherein the lower surface 4 of the backing layer 2 is heated to melt the pile fibres 5 in the bundles 6 to each other and/or to the backing layer 2 to strengthen the fibre-bind. During the bonding step, the backing layer 2 is simultaneously heat-set to reduce the spread of the artificial turf substrate during use and improve the dimensional stability. This type of bonding is here referred to as a “thermo-fixation” step.

FIG. 3 shows an exemplary embodiment of an apparatus 20 that can be used to carry out the fibre bonding step 12. The intermediate product 17, consisting of the HDPE backing layer 2 with integrated pile fibres 5 is provided by a feed roller 21 and guided through the apparatus 20 using a plurality of guiding rollers 22. The intermediate product 17 is carried through the machine at a speed between 1 and 30 m/min and guided along the heated surface 25 of a roller 24. The heated roller 24 melts the individual pile fibres 5 in the bundles 6, thereby also increasing the bond between the pile fibres 5 and the backing layer 2. Importantly, the backing layer 2 itself does not engage the roller 24 and remains spaced therefrom by the pile fibres 5.

Optionally, a hot melt adhesive or powder melt may be applied to further increase the fibre bind strength. A device 23, for instance be a sprinkling device, may be arranged in the apparatus 20. The device 23 may sprinkle hot melt adhesive powder on the lower surface 4 before the intermediate product 17 is carried along the heated roller 24. This hot melt or powder melt can substantially consist of polyethylene, such that the recyclability of the artificial turf substrate is not compromised. Alternatively, no hot melt adhesive or powder melt is applied, which makes the production process less complex and as such cheaper and less prone to errors.

For processing a backing layer 2 with the HDPE composition as described above, the heated surface 25 is heated to a temperature in the range of 135-155 degrees Celsius. The heated surface 25 is typically a drum, made of a non-adhesive material to prevent the intermediate product 17 from sticking against the surface 25. The guiding rollers 22 are arranged to place the intermediate product 17 under tension and control the residence time of the intermediate product 17 at the heated surface 25. Generally, the rollers 22, 24 are arranged with respect to each other to allow for a residence time between 10 and 40 seconds. Preferably, the residence time is between 22 and 35 seconds, for example 25 seconds. This contact period allows the backing layer 2 and/or pile fibres 5 to melt sufficiently and partially fuse with each other to provide a sufficiently high fibre bind strength. The partially melted intermediate product 17 is subsequently carried away by a guide roller 22 and transported out of the apparatus for further treatment. Such further treatment may include the accelerated cooling of the artificial turf substrate or laminating the lower surface of the backing layer. In embodiments, the product after cooling is the final product.

The guide rollers 22 may only guide the intermediate product 17 through the apparatus 20, yet may also be placed adjacent to the heated roller 24 and used as pressure rollers that can increase the pressure on the lower surface 4 of the backing layer 2 to better spread the molten polymer material between the warp and weft fibres of the backing layer 2 and the pile fibres 5. It will be understood by those skilled in the art that the temperature of the heated roller 25 and the pressure applied to such a pressure roller should be optimized in dependence of each other and in dependence of the characteristics and texture of the intermediate product 17 to achieve good results.

### Method of Fibre Bond—Example 1

According to a first example of the method, the temperature of the roller is set to 145 degrees Celsius as measured on the heated cylinder and a residence time of 25 seconds. A pressure of 5 Bar is applied. This method was tested on the first exemplary backing layer after it had been subjected to a heat-stabilization step.

### Method of Fibre Bond—Example 2

According to a second example of the method, the temperature of the roller is arranged at 145 degrees Celsius as measured on the heated cylinder and a residence time of 30 seconds. A pressure of 5 Bar is applied. This method was tested on the second exemplary backing layer.

Mechanical properties of the artificial turf substrate according to the first and second example are summarized in Table 2.

TABLE 2

| | | Strength at | Strength at | Shrinkage | Shrinkage | | Dimensional |
|---|---|---|---|---|---|---|---|
| | Weight | Fₘₐₓ MD | Fₘₐₓ CD | at 90° C. | at 90° C. | Tuftbind | stability |
| Backing layer | [g/m²] | [N/5 cm] | [N/5 cm] | MD [%] | CD [%] | [N] | [%] |
| Example 1 | 1548 | 814 | 892 | 0.4 | 0 | 21 | −0.4 |
| Example 2 | 1693 | 1592 | 895 | 0 | 0 | 19 | −0.07 |

The second backing layer was not heat stabilized before applying the thermofixation step. This reduces the cost and complexity of manufacture. Nevertheless, it will be understood that embodiments wherein the backing layer is first heat-stabilized before the thermofixation step are not excluded.

FIG. 5 illustrates a typical Differential Scanning calorimetry (DSC) trace. The melting point of the material is determined as the peak value for the heat flow. The onset temperature at point D is defined as the intersection point of the extrapolated baseline and the inflectional tangent at the beginning of the melting or crystallization peak. The inflectional tangent is indicated between points B and D. The extrapolated baseline is indicated between points A and C.

The HDPE filaments according to the first example have an onset temperature of approximately 125 degrees Celsius, and a melting point of approximately 130 degrees Celsius.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. It will be apparent to the person skilled in the art that alternative and equivalent embodiments of the invention can be conceived and reduced to practice. All changes which come within the meaning and range of equivalency of the claims are to be embraced within their scope.

1. A polyethylene backing layer for an artificial turf substrate consisting essentially of highly oriented, high density polyethylene filaments forming warp and weft threads, the high density polyethylene filaments having a density of at least 945 kg/m³ and a melt flow index of maximum 2 g/10 min.

2. The backing layer according to claim 1, wherein the high density polyethylene filaments have a density of at least 950 kg/m³, preferably a density between 950 kg/m³ and 970 kg/m³.

3. The backing layer according to claim 1 or 2, wherein the high density polyethylene filaments have a melt flow index between 1.5 and 2 g/10 min, preferably between 1.7 and 1.9 g/10 min.

4. The backing layer according to any of the preceding claims, wherein the high density polyethylene has a medium or medium-broad molecular weight distribution.

5. The backing layer according to any of the preceding claims, wherein the high density polyethylene has a melting point of at least 125 degrees Celsius, preferably at least 130 degrees Celsius.

6. The backing layer according to any of the preceding claims, wherein at least some of the filaments are tapes.

7. The backing layer according to claim 6, wherein the backing layer is a primary backing layer suitable for tufting.

8. The backing layer according to claim 7, wherein the backing layer is woven using a plain weave.

9. The backing layer according to claim 7 or 8, wherein the number of warp filaments per unit length and weft filaments per unit length are different.

10. The backing layer according to claim 9, wherein the ratio of the number of warp filaments to the number of weft filaments is the inverse of the ratio of the linear density of a warp filament to the linear density of a weft filament.

11. The backing layer according to any of claim 6-10, wherein the backing layer comprises a plurality of sublayers, preferably wherein the backing layer consists of two sublayers which are identical to each other.

12. The backing layer according to any of the preceding claims, wherein the filaments have a linear density between 100 and 2500 dtex, preferably between 200 and 1700 dtex, optionally in the range from 600 dtex to 1200 dtex.

13. The backing layer according to any of the preceding claims, wherein the filaments have at least a tenacity of 20 cN/Tex, preferably wherein the filaments have at least a tenacity of 25 cN/Tex.

14. The backing layer according to any of the preceding claims having a fabric weight between 80 and 400 g/m², preferably between 100 and 300 g/m²

15. The backing layer according to any of the preceding claims wherein the individual filaments have a strain at break between 10 and 40%, preferably between 20 and 35%.

16. The backing layer according to any of the preceding claims, wherein the filaments may further comprise one or more additives preferably selected from the group comprising antioxidants, UV stabilizers, pigments, processing aids, acid scavengers, lubricants, antistatic agents, fillers, nucleating agents, and clarifying agents.

17. The backing layer according to any of the preceding claims, wherein the backing layer has been heat-stabilized.

18. The backing layer according to any of the preceding claims, wherein the filaments have one or more elongate ribs of grooves along their longitudinal direction.

19. A method of manufacturing a high density polyethylene backing layer, the method comprising:
1 providing a plurality of highly-oriented, high density polyethylene filaments having a density of at least 945 kg/m³ and a melt flow index of maximum 2 g/10 min.
weaving the backing layer, wherein the high density polyethylene filaments are used both as warp threads and as weft threads.

20. The method according to claim 19, wherein the backing layer is a backing layer according to any of claims 1-18.

21. The method according to claim 19 or 20, further comprising heat-stabilizing the backing layer by heating the backing layer above a melting temperature of the high density polyethylene.

22. The method according to claim 21 wherein the heat-stabilization is performed by feeding the backing layer along a body having a heated surface, a first surface of the backing layer being arranged to contact the heated surface.

23. The method according to claim 21, wherein the heat-stabilization is performed by guiding the backing layer through an oven, preferably wherein the oven has a temperature between 135 and 155 degrees and wherein preferably the backing layer has a residence time between 10 and 120 seconds.

24. A method of manufacturing a polyethylene, heat-stabilized artificial turf substrate, the method comprising:
providing a high density polyethylene backing layer according to any of claims 1-18 or forming a backing layer according to any of claims 21-23, the backing layer having an upper surface and a lower surface;
integrating pile fibres into the backing layer to be upstanding from the upper surface, wherein the pile fibres comprise polyethylene; and
bonding the pile fibres to the backing layer to prevent fibre pull-out.

25. The method according to claim 24, wherein bonding takes place by feeding the substrate along a body having a heated surface, the lower surface of the backing layer being arranged to contact the heated surface.

26. The method according to claim 25 wherein the heated surface is between 135 and 155 degrees and a contact period is between 20 and 35 seconds, preferably between 25 and 30 seconds.

27. The method according to claim 25 or 26, wherein a roller is arranged opposite to the heated surface to pressurize the backing layer, preferably wherein a pressure between 2 and 8 Bar is applied.

28. The method according to any of claims 24-27, further comprising applying a hot melt or powder melt to the lower surface of the backing layer comprising the same polymer material.

29. The method according to any of claims 24-28, further comprising laminating the lower surface of the backing layer with a polyethylene film, wherein lamination takes place by melting the film.

30. An artificial turf substrate consisting essentially of polyethylene material, the artificial turf substrate comprising a backing layer comprising backing filaments and pile fibres upstanding from the backing layer, wherein the backing filaments comprise polyethylene having a first density and the pile fibres comprise polyethylene having a second density, wherein the ratio between the first and second density is at least 1.01.

31. An artificial turf substrate consisting essentially of polyethylene material, the artificial turf substrate comprising a backing layer comprising backing filaments and pile fibres upstanding from the backing layer, wherein the backing filaments comprise polyethylene having a first melting temperature and the pile fibres comprise polyethylene having a second melting temperature, and the first melting temperature is at least 2 degrees higher, preferably at least 3 degrees higher than the second melting temperature.

32. The artificial turf substrate according to claim 30 or 31, wherein the backing layer is a backing layer according to any of claims 1-18.

33. The artificial turf substrate according to any of claims 30-32, wherein the backing layer has an upper surface and a lower surface, the pile fibres being tufted into the backing layer and bonded to each other or to the backing layer at the lower surface.

34. The artificial turf substrate according to any of claims 30-33, wherein the artificial turf substrate comprises at least 98 wt. % of polyethylene, preferably at least 99 wt. % of polyethylene.

35. The artificial turf substrate according to any of claims 30-34, wherein the pile fibres are arranged in bundles of monofilaments, each bundle having a linear density between 10000 dtex and 15000 dtex.

36. The artificial turf substrate according to any of claims 30-35, wherein the bundles of monofilaments are at least partly melted to each other.

37. A highly-oriented, high density polyethylene filament suitable for use in a backing layer according to any of claims 1-18.

38. A method of manufacturing a high density polyethylene filament for a backing layer of an artificial turf substrate, the method comprising
providing a high density polyethylene composition having a density of at least 945 kg/m³ and a melt flow index between 1.5 and 2 g/10 min to an extruder;
forming filaments;
drawing the filaments in a machine direction to obtain a tape having a linear density between 100 and 2500 dTex.

39. The method according to claim 38, wherein the draw ratio in the drawing step is at least 4, preferably at least 5, more preferably at least 6.

40. The method according to claim 38 or 39, wherein the filaments are tapes and wherein the step of forming the filaments comprises:
extruding the polyethylene composition into an extruded film;
slitting the film into tapes.

41. The method according to claim 40, wherein the film is extruded through a profiled die having at least one ribbed surface.

42. The method according to any of claims 38-41, wherein the high density polyethylene filament is suitable for application in a backing layer according to any of claims 1-18 or an artificial turf substrate according to any of claims 30-36.
